(19) United States
(12) Patent Application Publication
(10) Pub. No.: US 2008/0316189 A1
(43) Pub. Date: Dec. 25, 2008

(54) DISPLAY DEVICE

(76) Inventors: Uk-Chul CHOI, Cheonan-si (KR); Sung-Jin HONG, Seoul (KR); Cheol-Woo PARK, Suwon-si (KR); Seong-Sik SHIN, Seongnam-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/015,853

(22) Filed: Jan. 17, 2008

(30) Foreign Application Priority Data
Jun. 25, 2007 (KR) 10-2007-0062191

(51) Int. Cl. G09G 5/00

(52) U.S. Cl. 345/204; 345/107

(57) ABSTRACT

A display device includes a display panel assembly that includes a plurality of pixels and a plurality of signal lines connected to the pixels, and a driver that includes a plurality of stages connected with one another for sequentially generating output signals in synchronization with a plurality of clock signals. Portions of the plurality of stages output the output signals to the display panel assembly.

### CROSS-REFERENCE TO RELATED APPLICATION

This application claims priority to and the benefit of Korean Patent Application No. 10-2007-0062191 filed in the Korean Intellectual Property Office on Jun. 25, 2007, the entire contents of which are incorporated herein by reference.

### BACKGROUND OF THE INVENTION

1. Field of the Invention

The present invention relates to a display device.

2. Description of the Related Art

There has been much research actively directed to developing a flat panel display that uses an electrophoretic display device (EPD) or a liquid crystal display (LCD).

An electrophoretic display includes a panel assembly having pixels, each of which includes a switching element connected to an electrophoretic capacitor and to the display's signal lines. An image scanning driver turns on/off the switching elements of the pixels. A scanning signal formed of a gate-on voltage and a gate-off voltage is applied to gate lines associated with the switching elements. An image data driver applies data voltages to data lines that conduct the data voltages to pixels through turned-on ones of the switching elements.

In addition, touch sensible displays having a contact sensible function have been developed. The touch sensible display includes a sense scanning driver and a sense signal processor as well as the display panel assembly, the image scanning driver, and the data driver.

The image scanning driver and the sense scanning driver are substantially comprised of respective shift registers each including a plurality of sequentially arranged stages. The first stage of the stages is supplied with a scanning start signal to output a scanning signal or a sense scanning signal to the panel assembly and to simultaneously output a carry signal to the next stage. Thereby the plurality of stages sequentially output the scanning signals or the sense scanning signals in synchronization with the carry signal.

When images are displayed only on portions of the entire screen, it is unnecessary to again display the same images as previous images. In addition, when the contact sensible function is performed on portions of the entire screen, it is unnecessary to sequentially apply the sense scanning signal to the entire screen.

### SUMMARY OF THE INVENTION

According to an embodiment of the present invention, a display device is provided, which includes a display panel assembly that includes a plurality of pixels and a plurality of signal lines connected to the pixels, and a driver that includes a plurality of stages connected with one another for sequentially generating output signals in synchronization with a plurality of clock signals, wherein portions of the plurality of stages output the output signals to the display panel assembly.

The driver may include an image scanning driver that applies image scanning signals to the signal lines. Each of the plurality of stages may include an input unit that outputs a first voltage in response to one of output signals from a previous stage or a scanning start signal, a second input unit that outputs a second voltage in response to one of the plurality of clock signals or one of output signals from a next stage, an output voltage generator for charging the first voltage and generating the output signal in response to the output signals from the first input unit and the second input unit, and an output determiner that determines whether the output signal from the output voltage generator is output to the display panel assembly.

Each of the plurality of stages may include a first selection terminal, and the output determiner determines whether the output signal outputs to the display panel assembly based on a first selection signal that is applied to the first selection terminal.

The output determiner may include a first transistor including a first terminal, a second terminal, and a control terminal. The first terminal may be connected to the output voltage generator, the second terminal may be connected to the output terminal, and the control terminal may be connected to the first selection terminal.

Each of the plurality of stages may further include a set terminal, a reset terminal, and first and second clock terminals. The first input unit may be connected to the set terminal and a first junction, and includes a second terminal having a control terminal connected to the set terminal. The second input unit may include a third transistor and a fourth transistor connected in parallel between the first junction and a gate voltage terminal, a fifth transistor connected to a second junction and the gate voltage terminal, and a first capacitor connected to the second junction and the first clock terminal. The third transistor may include a control terminal connected to the reset terminal, the fourth transistor includes a control terminal connected to second junction, and the fifth transistor includes a control terminal connected to the first junction. The output voltage generator may include a sixth transistor connected to a third junction and the first clock terminal, a seventh transistor and an eighth transistor connected in parallel between the third junction and the gate voltage terminal, and a second capacitor connected to the first junction and the third junction. The sixth transistor may include a control terminal connected to the first junction, the seventh transistor may include a control terminal connected to the second junction, and the eighth transistor may include a control terminal connected to the second clock terminal. The first terminal of the first transistor may be connected to the third junction.

At least one of the plurality of stages may further include a carry out terminal that transmits the output signal to a previous stage and a next stage.

Each of the plurality of stages may further include a second selection terminal, and the output determiner may determine whether the output signal outputs to the display panel assembly based on a second selection signal that is applied to the second selection terminal.

The output determiner may further include a second transistor including a first terminal, a second terminal, and a control terminal. The first terminal may be connected to a gate voltage terminal, the second terminal may be connected to the output terminal, and the control terminal may be connected to the second selection terminal.

The first transistor and the second transistor may operate opposite to each other, and the first selection signal and the second selection signal may be opposite in phase.

Each of the plurality of stages may further include a set terminal, a reset terminal, and first and second clock terminals. The input unit may include a third transistor that is connected between the set terminal and a first junction, and has a control terminal connected with the set terminal. The second input units may include fourth and fifth transistors connected in parallel between the first junction and the gate voltage terminal, a sixth transistor connected between a second junction and the gate voltage terminal, and a first capacitor connected between the second junction and the first clock terminal, wherein the fourth transistor may have a control terminal connected with the reset terminal, the fifth transistor may have a control terminal connected with the second junction, and the sixth transistor may have a control terminal connected with the first junction. The output voltage generator may include a seventh transistor connected between a third contact and the first clock terminal, eighth and ninth transistors connected in parallel between the third junction and the gate voltage terminal, and a second capacitor connected between the first junction and the third junction, wherein the seventh transistor has a control terminal connected with the first junction, the eighth transistor has a control terminal connected with the second junction, and the ninth transistor has a control terminal connected with the second clock terminal. The first and second transistors may be connected with the third junction.

The at least one of the plurality of stages may further include a carry output terminal that outputs the output signal to previous and next stages.

The output determiner may output one of the output signal and a voltage applied to the gate voltage terminal based on the first selection signal.

The output determiner may include a first transistor including a first terminal, a second terminal, and a control terminal, and a second transistor including a first terminal, a second terminal, and a control terminal. The first terminal of the first transistor may be connected to the output voltage generator, the second terminal of the first transistor may be connected to the output terminal, and the control terminal of the first transistor may be connected to the output voltage generator, and the first terminal of the second transistor may be connected to the gate voltage terminal, the second terminal of the second transistor may be connected to the output terminal, and the control terminal of the second transistor may be connected to the first selection terminal.

Each of the plurality of stages may further include a set terminal, a reset terminal, and first and second clock terminals. The input unit may include a third transistor that is connected between the set terminal and a first junction, and may have a control terminal connected with the set terminal. The second input unit may include fourth and fifth transistors connected in parallel between the first junction and the gate voltage terminal, a sixth transistor connected between a second junction and the gate voltage terminal, and a first capacitor connected between the second junction and the first clock terminal. The third transistor may have a control terminal connected with the reset terminal, the fifth transistor may have a control terminal connected with the second junction, and the sixth transistor may have a control terminal connected with the first junction. The output voltage generator may include a seventh transistor connected between a third contact and the first clock terminal, eighth and ninth transistors connected in parallel between the third junction and the gate voltage terminal, and a second capacitor connected between the first junction and the third junction. The sixth transistor may have a control terminal connected with the first junction, the eighth transistor may have a control terminal connected with the second junction, and the ninth transistor may have a control terminal connected with the second clock terminal. The first terminal of the first transistor may be connected to the third junction.

The at least one of the plurality of stages may further include a carry output terminal that outputs the output signal to previous and next stages.

The driver may include a sense scanning driver that applies sense scanning signals to the signal lines. One stage of the plurality of stages may include an input signal determiner that outputs a scanning start signal or one of output signals of previous stages, an input unit that outputs a first voltage in response to an output signal from the input signal determiner, a second input unit that outputs a second voltage in response to one of the plurality of clock signals or one of output signals from a next stage, and an output voltage generator for charging the first voltage and generating the output signal in response to the output signals from the first input unit and the second input unit.

The one stage may include a first set terminal, a second set terminal, a first selection terminal, and a second selection terminal, and the input signal determiner may output one of a signal from the first set terminal and a signal from the second set terminal based on signals applied to the first selection terminal and the second selection terminal to the first input unit.

The input signal determiner may include a first transistor including a first terminal, a second terminal, and a control terminal. The first terminal may be connected to the first set terminal, the second terminal may be connected to the first input unit, and the control terminal may be connected to the first selection terminal.

The input signal determiner may further include a second transistor including a first terminal, a second terminal, and a control terminal. The first terminal may be connected to the second set terminal, the second terminal may be connected to the first input unit, and the control terminal may be connected to the second selection terminal.

The one stage may further include a reset terminal, first and second clock terminals, and a gate voltage terminal. The first input unit may be connected to the input signal determiner and a first junction, and may include a third transistor having a control terminal connected to the input signal determiner. The second input unit may include a fourth transistor and a fifth transistor connected in parallel between the first junction and the gate voltage terminal, a sixth transistor connected to a second junction and the gate voltage terminal, and a first capacitor connected to the second junction and the first clock terminal. The fourth transistor may include a control terminal connected to the reset terminal, the fifth transistor may include a control terminal connected to the second junction, and the sixth transistor may include a control terminal connected to the first junction. The output voltage generator may include a seventh transistor connected to a third junction and the first clock terminal, an eighth transistor and a ninth transistor connected in parallel between the third junction and the gate voltage terminal, and a second capacitor connected to the first junction and the third junction. The seventh transistor may include a control terminal connected to the first junction, the eighth transistor may include a control terminal connected to the second junction, and the ninth transistor may include a control terminal connected to the second clock terminal.

The at least one of the plurality of stages may further include a carry out terminal that transmits the output signal to a previous stage and a next stage.

### BRIEF DESCRIPTION OF THE DRAWINGS

The present invention will become more apparent by describing preferred embodiments thereof in detail with reference to the accompanying drawings, in which:

FIG. 1 is a block diagram of an electrophoretic display device according to an exemplary embodiment of the present invention;

FIG. 2 is an equivalent circuit diagram of a pixel and a sensing unit in an electrophoretic display device according to an exemplary embodiment of the present invention;

FIG. 3 is a cross-sectional view of an electrophoretic panel assembly of an electrophoretic display device according to an exemplary embodiment of the present invention;

FIG. 4 is a block diagram of an example of an image scanning driver according to an exemplary embodiment of the present invention;

FIG. 5 is a block diagram of another example of an image scanning driver according to an exemplary embodiment of the present invention;

FIG. 6 is a circuit diagram of an example of an i-th stage of a shift register for the image scanning driver shown in FIG. 4;

FIG. 7 is a circuit diagram of an example of an i-th stage of a shift register for the image scanning driver shown in FIG. 5;

FIG. 8 is a circuit diagram of another example of an i-th stage of a shift register of the image scanning driver shown in FIG. 4;

FIG. 9 is a signal waveform of signals for driving the image scanning driver shown in FIG. 4;

FIG. 10 is a signal waveform of signals for driving the image scanning driver shown in FIG. 5;

FIG. 11 is a signal waveform of signals for driving an image scanning driver having the shift register shown in FIG. 8;

FIG. 12 is a block diagram of an electrophoretic display device according to another exemplary embodiment of the present invention;

FIG. 13 is an equivalent circuit diagram of a pixel in an electrophoretic display device according to another exemplary embodiment of the present invention;

FIG. 14 is a cross-sectional view of an electrophoretic panel assembly of an electrophoretic display device according to another exemplary embodiment of the present invention;

FIG. 15 is a block diagram of a sense scanning driver according to an exemplary embodiment of the present invention;

FIG. 16 is a circuit diagram of an i-th stage of a shift register for the sense scanning driver shown in FIG. 15;

FIG. 17 is a circuit diagram of a k-th stage of a shift register for the sense scanning driver shown in FIG. 15; and

FIG. 18 is a signal waveform of signals for driving the sense scanning driver shown in FIG. 15.

### DETAILED DESCRIPTION OF THE EMBODIMENTS

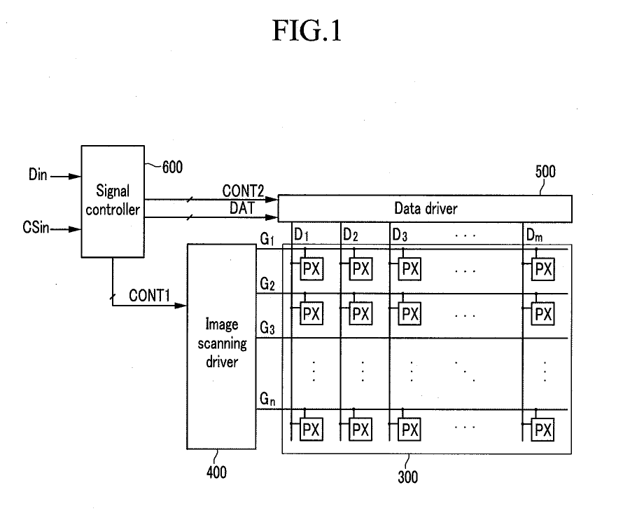

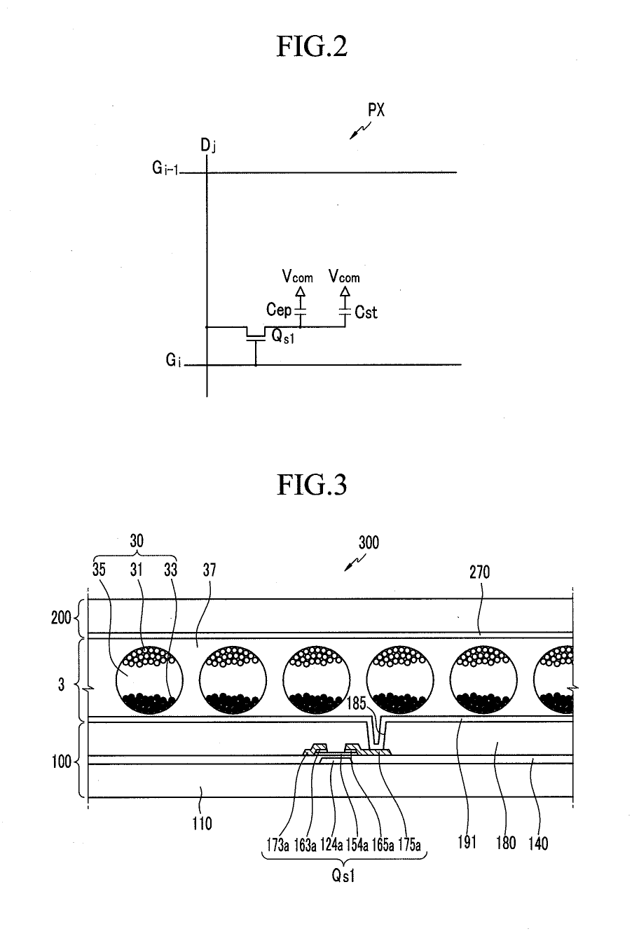

FIG. 1 is a block diagram illustrating an electrophoretic display device according to an exemplary embodiment of the present invention, FIG. 2 is an equivalent circuit diagram of a pixel and a sensor in an electrophoretic display device according to an exemplary embodiment of the present invention, and FIG. 3 is a cross-sectional view of an electrophoretic panel assembly of an electrophoretic display according to an exemplary embodiment of the present invention.

As shown in FIG. 1, the electrophoretic display according to an exemplary embodiment includes an electrophoretic panel assembly 300, an image scanning driver 400, a data driver 500, and a signal controller 600.

As shown in the equivalent circuit diagram of FIG. 2, the electrophoretic panel assembly 300 includes a plurality of display signal lines G₁-Gₙ and D₁-Dₘ, and a plurality of pixels PX. Further, as shown in FIG. 3, the electrophoretic panel assembly 300 includes respective lower and upper panels 100 and 200 facing each other, and an electrophoretic layer 3 interposed between the lower and upper panels 100 and 200.

The display signal lines G₁-Gₙ and D₁-Dₘ are formed on an insulation substrate 110, made of transparent glass or plastic, of the lower panel 100. Image scanning lines G₁-Gₙ are for transferring an image scanning signal and a plurality of image data lines D₁-Dₘ are for transferring an image data voltage. The image scanning lines G₁-Gₙ extend substantially in a row direction to run almost parallel to each other, and the image data lines D₁-Dₘ extend substantially in a column direction to run almost parallel to each other.

As shown in FIGS. 2 and 3, each pixel PX, for example a pixel PX connected to an i-th image scanning line Gᵢ and a j-th image data line Dⱼ, includes a switching element Qs1 connected to the display signal lines Gᵢ and Dⱼ, and an electrophoretic capacitor Cep and a storage capacitor Cst that are connected to the switching element Qs1, where i=1, 2, . . . , n and j=1, 2, . . . , m.

The switching element Qs1 is a three terminal element such as a thin film transistor disposed on the lower panel 100. The switching element Qs1 includes a control terminal 124a connected to an image scanning line Gᵢ, an input terminal 173a connected to an image data line Dⱼ, and an output terminal 175a connected to an electrophoretic capacitor Cep and a storage capacitor Cst. Also, the switching element Qs1 includes a semiconductor 154a formed between the control terminal 124a and the input terminal 173a and between the control terminal 124a and the output terminal 175a, and ohmic contacts 163a and 165a formed on the semiconductor 154a.

The electrophoretic capacitor Cep includes one of a plurality of pixel electrodes 191 of the lower panel 100 and a common electrode 270, which is formed on an insulating substrate 210 of the upper panel 200, as two terminals, and the electrophoretic layer 3 between the two electrodes 191 and 270 operates as a dielectric material.

One pixel electrode 191 is connected to one switching element Qs1. The common electrode 270 is formed on the entire surface of the upper panel 200 and receives a common voltage Vcom. The pixel electrodes 191 are made of a transparent conductor or an opaque metal such as ITO or IZO, and the common electrode 270 is made of a transparent conductor. A passivation layer 180 is interposed between the pixel electrodes 191 and the switching elements Qs1. The pixel electrodes 191 are connected to the output terminals 175a of the switching elements Qs1 through contact holes 185 of the passivation layer 180, respectively.

The electrophoretic layer 3 includes a plurality of microcapsules 30 and a binder 37 for fixing the microcapsules 30. Each of the microcapsules 30 includes a white electrophoretic particle 31 charged with a negative charge (−) or a positive charge (+), a black electrophoretic particle 33 charged with the opposite charge, and a transparent dielectric fluid 35.

The storage capacitor Cst includes the pixel electrode 191 and a separate signal line (not shown), which is provided on the lower panel 100, overlaps the pixel electrode 191 via an insulator, and is supplied with a predetermined voltage such as the common voltage Vcom. Alternatively, the storage capacitor Cst includes the pixel electrode 191 and an adjacent image scanning line called a previous image scanning line, which overlaps the pixel electrode 191 via an insulator.

The semiconductor 154a of the switching element Qs1 may be formed of an amorphous silicon or polysilicon thin film transistor. The ohmic contacts 163a and 165a may be made of n+ hydrogenated a-Si heavily doped with an N-type impurity, or they may be made of silicide. The control terminal 124a and the semiconductor 154a of the switching element Qs1 are insulated from each others by a gate insulating layer 140 made of silicon nitride (SiNx).

The image scanning driver 400 is connected to image scanning lines G₁-Gₙ for applying image scanning signals to the image scanning lines G₁-Gₙ. Each of the image scanning signals includes a voltage Von (referred to as a “gate-on voltage”) for turning on the switching elements Qs1 and a voltage Voff (referred to as a “gate-off voltage”) for turning off the switching elements Qs1.

The data driver 500 is connected to the image data lines D₁-Dₘ of the panel assembly 300 and applies image data voltages to the data lines D₁-Dₘ.

At least one of the image scanning driver 400 and the data driver 500 may include at least one integrated circuit (IC) chip mounted on the LC panel assembly 300 or on a flexible printed circuit (FPC) film in a tape carrier package (TCP) type, which are attached to the panel assembly 300. Alternatively, at least one of the image scanning driver 400 and the data driver 500 may be integrated into the panel assembly 300 along with the signal lines G₁-Gₙ and D₁-Dₘ and the switching elements Qs1.

The signal controller 600 controls the image scanning driver 400 and the data driver 500.

The electrophoretic display device further includes a gray voltage generator for generating gray voltages and providing the generated gray voltages to the data driver 500. In this case, the data driver 500 applies gray voltages or divided gray voltages to the image data lines D₁-Dₘ as image data voltages.

Hereinafter, the displaying operation of the above electrophoretic display device will be described in detail.

The signal controller 600 receives input image signals Din from an external graphics controller (not shown) and input control signals CSin for controlling the display of the input image signals. For example, the input control signals CSin include a vertical synchronization signal, a horizontal synchronizing signal, a main clock signal, etc.

The signal controller 600 appropriately processes the input image signals Din to be suitable for the operation of the electrophoretic panel assembly 300 based on the input control signals CSin, and generates gate control signals CONT1, data control signals CONT2, and output image signals DAT. Then, the signal controller 600 transmits the gate control signals CONT1 to the image scanning driver 400, and the data control signals CONT2 and the output image signals DAT to the data driver 500.

The image scanning control signals CONT1 include a scanning start signal STV for starting the image scanning signal, at least one clock signal for controlling the output of the image scanning signal, and a selection signal for applying the image scanning signal to portions of the image scanning lines G₁-Gₙ. The image scanning control signal CONT1 further includes an output enable signal OE for limiting the duration of a gate-on voltage Von.

The image data control signals CONT2 include a horizontal synchronization start signal STH for starting the data transmission of one pixel row, a load signal LOAD for applying a corresponding image data voltages to the image data lines D₁-Dₘ, and a data clock signal HCLK.

Responsive to the data control signals CONT2 from the signal controller 600, the data driver 500 receives a packet of the digital output image signals DAT for one pixel row from the signal controller 600, converts the digital output image signals DAT into analog image data voltages selected from the gray voltages, and applies the analog data voltages to the image data lines D₁-Dₘ. The output image signals DAT have voltage information that is applied to the image data lines D₁-Dₘ for one pixel row. Values of the output image signals DAT are varied based on the comparison result of a previous image and a current image.

For example, when current images for one pixel row are compared with previous images and only portions of the current images are changed, pixels corresponding to the changed images are supplied with data voltages corresponding to the changed current images. However, pixels corresponding to the unchanged images are not supplied with data voltages corresponding to the current images such that the previous images are still displayed. That is, the pixels corresponding to the unchanged images are not supplied with any voltage, or are supplied with a common voltage Vcom that does not influence the change of the previous images. Thereby, only the pixels corresponding to the changed image display the changed current images.

The image scanning driver 400 applies the gate-on voltage Von to portions of the image scanning lines G₁-Gₙ in response to the image scanning control signals CONT1 from the signal controller 600, thereby turning on the switching elements Qs1 connected to the portions of the image scanning lines G₁-Gₙ. The image data voltages applied to the image data lines D₁-Dₘ are then supplied to the corresponding pixels PX through the turned-on switching elements Qs1.

The difference between an image data voltage and the common voltage Vcom applied to a pixel PX is represented as a voltage across the electrophoretic capacitor Cep of the pixel PX, which is referred to as a pixel voltage. The locations of the electrophoretic particles 31 and 33 vary in the microcapsule 30 according to a magnitude of the pixel voltage, a polarity of the pixel voltage, a time of applying the pixel voltage, etc.

For example, if a white electrophoretic particle 31 is located closer to the common electrode 270, the electrophoretic display device displays white. On the contrary, if a black electrophoretic particle 33 is located closer to the common electrode 270, the electrophoretic display device displays black. If white and black electrophoretic particles 31 and 33 are located in the middle of a microcapsule 30, the electrophoretic display device displays a gray level. As described above, the electrophoretic display device displays various gray-scale images by changing the locations of the electrophoretic particles 31 and 33 in the microcapsules 30.

In summary, the signal controller 600 has information about a section (referred to as a “image change section”), in which displayed images are changed in a current frame as compared with a previous frame, transmits information for the image scanning signal lines based on the section information to the image scanning driver 400 through the image scanning control signal CONT1, and transmits information for the image data lines based on the section information to the data driver 500 through the output image signals DAT.

For displaying images on a screen, when the scanning start signal is applied to the image scanning driver 400, the pixels for the first pixel row are capable of displaying images. The image scanning driver 400 determines whether an image scanning signal outputs to the first scanning signal line G₁ in accordance with the image control signals CONT1, and applies the image scanning signal to the first scanning signal line G₁ when the first pixel row is included in the image change section. At this time, the data driver 500 transmits data voltages with respect to the changed images to pixels for displaying the changed images and transmits the common voltage Vcom to pixels corresponding to the unchanged images, that is, pixels displaying the same images as previous images.

When a predetermined period (one period of a horizontal synchronizing signal Hsync, and a data enable signal DE) passes, the image data driver 500 and the image scanning driver 400 repeatedly perform the same operation for the next row of pixels. Thereby, only images of the image change section are changed.

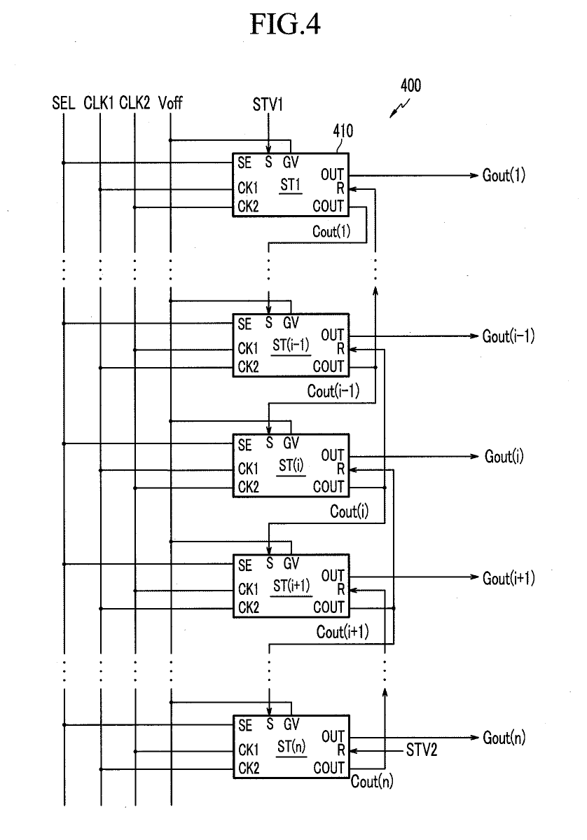

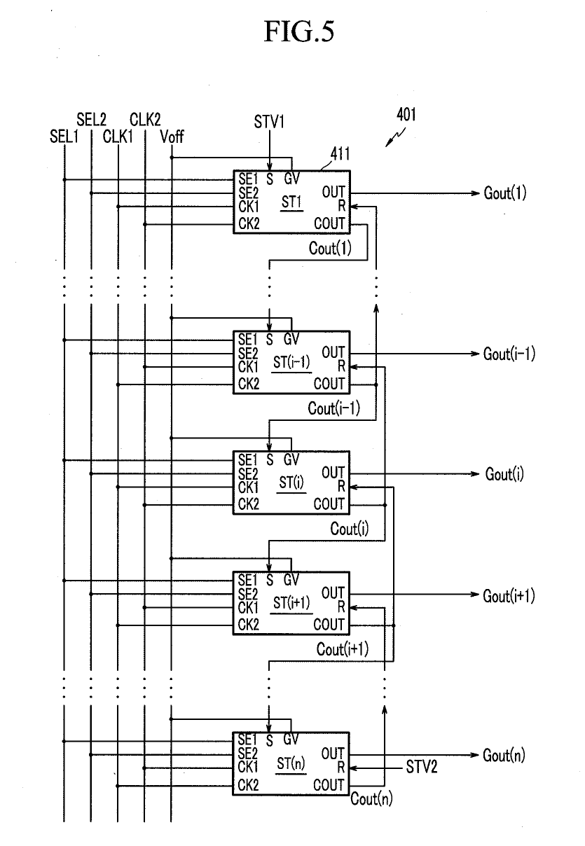

Hereinafter, an apparatus for driving a display device according to an exemplary embodiment of the present invention will be described with reference to FIGS. 4, 6, and 9.

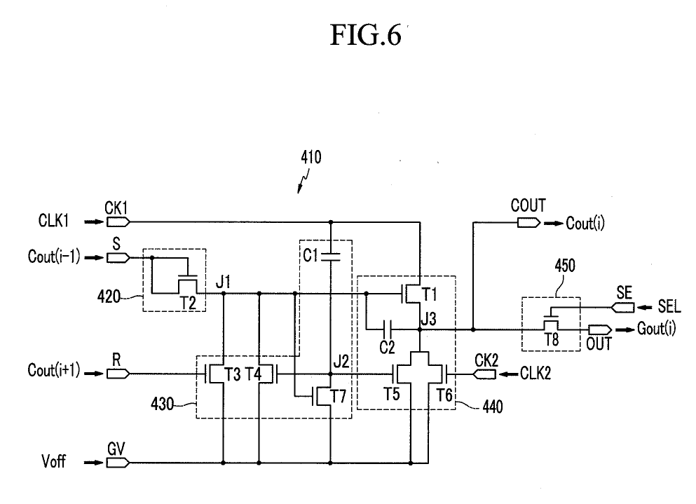

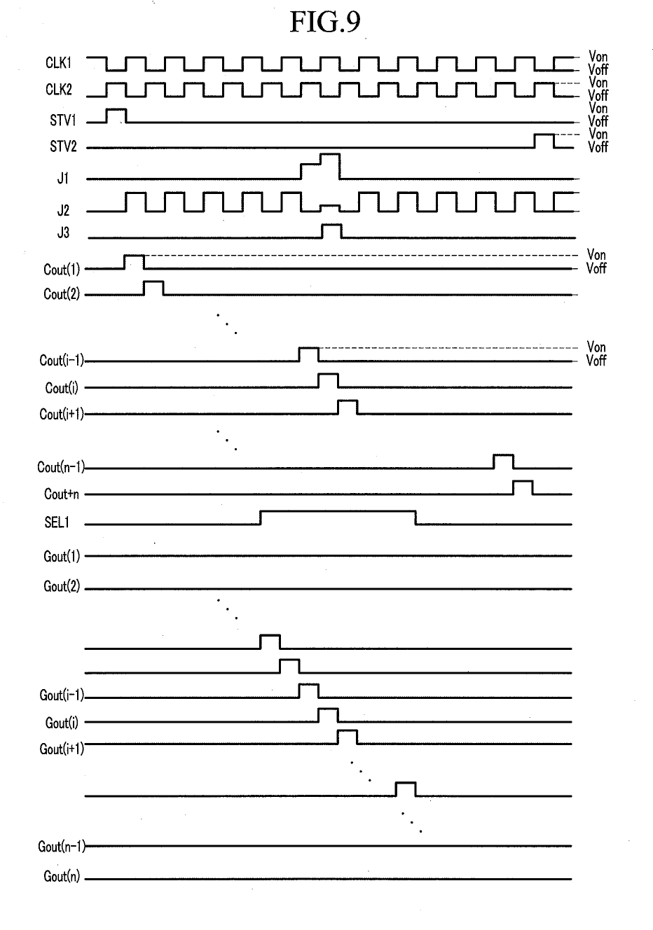

FIG. 4 is a block diagram illustrating an image scanning driver according to an exemplary embodiment of the present invention, FIG. 6 is a circuit diagram of an i-th stage of a shift register for the image scanning driver shown in FIG. 4, and FIG. 9 is a signal waveforms of signals for the image scanning driver shown in FIG. 4.

As shown in FIG. 4, the image scanning driver 400 is a shift register including a plurality of stages 410, each of which is connected to one of the image scanning lines G₁ to Gₙ. The image scanning driver 400 receives scanning start signals STV1 and STV2, clock signals CLK1 and CLK2, a selection signal SEL, and a gate-off voltage Voff.

Each of the stages 410 includes a set terminal S, a reset terminal R, a gate voltage terminal GV, an output terminal OUT, clock terminals CK1 and CK2, a selection terminal SE, and a carry output terminal COUT.

In each of the stages 410, for example an i-th stage [ST(i)], the set terminal S receives a carry signal [Cout(i−1)] of a previous stage [ST(i−1)], the reset terminal R receives a carry signal [Cout(i+1)] of the next stage [ST(i+1)], and the clock terminals CK1 and CK2 receive clock signals CLK1 and CLK2. The output terminal OUT1 outputs an image scanning output [Gout(i)] to an image scanning line Gᵢ.

Also, the selection terminal SE receives a selection signal. The carry output terminal COUT outputs a carry signal [Cout(i)] to the previous stage [ST(i−1)] and the next stage [ST(i+1)]. Herein, the carry signal may be the same as the image scanning output [Gout(i)].

In other words, each of the stages 410 generates a carry signal [Cout(i)] based on a carry signal [Cout(i−1)] of a previous stage [ST(i−1)] and a carry signal [Cout(i+1)] of the next stage [ST(i+1)], in synchronization with the clock signals CLK1 and CLK2. In addition, each of the stages 410 determines to output the carry signal [Cout(i)] as an image scanning output [Gout(i)] based on the selection signal SEL.

However, a scanning start signal STV1 is input to the first stage ST1 of a shift register instead of the carry signal of the previous stage, and a scanning start signal STV2 is input to the last stage [ST(n)] instead of the carry signal of the next stage.

The clock signals CLK1 and CLK2 have a duty ratio of about 50% and a phase difference of about 180°. For example, if a clock signal CLK1 is input to a clock terminal CK1 and a clock signal CLK2 is input to a clock terminal CK2 in an i-th stage [ST(i)], a clock signal CLK2 is input to a clock terminal CK1 and a clock signal CLK1 is input to a clock terminal CK2 in adjacent (i−1)-th and (i+1)-th stages [ST(i−1) and ST(i+1)].

Referring to FIG. 6, each of the stages 410 of the image scanning driver 400 according to this example, for example an i-th stage, includes a first input unit 420, a second input unit 430, an output voltage generator 440, and an output determiner 450. Each of the constituent elements includes at least one of N channel field effect transistors T1 to T8. Instead of the N channel field effect transistors, P channel field effect transistors can be used.

The first input unit 420 includes a transistor T2 connected to a set terminal S.

The transistor T2 includes an input terminal and a control terminal, which are commonly connected to the set terminal S, and functions as a diode. The transistor T2 outputs a gate-on voltage Von, which is a high voltage, to a junction J1.

The second input unit 430 outputs a gate-off voltage Voff, which is a low voltage, to junctions J1 and J2, and includes three transistors T3, T4, and T7 and a capacitor C1. The transistor T3 has a control terminal connected to a reset terminal R and outputs a gate-off voltage Voff to a junction J1. The transistor T4 includes a control terminal connected to a junction J2, and outputs a gate-off voltage Voff to a junction J1. The transistor T7 includes a control terminal connected to a junction J1, and outputs a gate-off voltage Voff to a junction J2. The capacitor C1 is connected between a clock terminal CK1 and a junction J2.

The output voltage generator 440 is connected between a first clock terminal CK1 and a gate-off voltage terminal GV, selectively outputs a first clock signal CLK1 and a gate-off voltage Voff to a junction J3 according to a voltage of junctions J1 and J2, and includes three transistors T1, T5, and T6, and a capacitor C2. The transistor T1 includes a control terminal connected to a junction J1, and outputs a clock signal CLK1 to a junction J3. The transistor T5 includes a control terminal connected to a junction J2, and outputs a gate-off voltage Voff to a junction J3. The transistor T6 includes a control terminal connected to a clock terminal CK2, and outputs a gate-off voltage Voff to a junction J3. The capacitor C2 is connected between a junction J1 and a junction J3.

The output determiner 450 includes a transistor T8 connected between an output terminal OUT and a junction J3. The transistor T8 includes a control terminal connected to the selection terminal SE, and transmits a voltage of the junction J3 to the output terminal OUT connected to the image scanning lines G₁ to Gₙ.

A carry output terminal COUT is connected to the junction J3, and transmits the voltage from the junction J3 to a reset terminal R of a previous stage [ST(i−1)] and a set terminal S of the next stage[ST(i+1)].

Hereinafter, the operation of the shift register shown in FIG. 6 will be described with reference to FIG. 9.

Before the operation of the shift register is described, it is required to consider that the previous stage [ST(i−1)] and the next stage [ST(i+1)] generate outputs in synchronization with a second clock signal CLK2 if the i-th stage [ST(i)] generates an output in consideration of a first clock signal CLK1. Also, a voltage level corresponding to a high voltage of the clock signals CLK1 and CLK2 is identical to a gate-on voltage Von, and refers to a high voltage. A voltage level corresponding to a low level is identical to a gate-off voltage Voff and refers to a low voltage.

Initially, when the first clock signal CLK1 transits to the low voltage and the second clock signal CLK2 and a previous carry signal [Cout(i−1)] transit to the high voltage, the transistors T2 and T6 are turned on. Then, the gate-on voltage Von is transferred to the junction J1 through the transistor T2. As a result, the transistors T1 and T7 are turned on. When the gate-off voltage Voff of the gate voltage terminal GV is transferred to the junction J2 through the transistor T7, the transistors T4 and T5 are turned off. At this moment, the transistor T3 is sustained in a turned-off state because the next carry signal [Cout(i+1)] is the low voltage. The gate-off voltage Voff is transferred to the junction J3 through the turned-on transistors T1 and T6.

When a previous carry signal [Cout(i−1)] and the second clock signal CLK2 transit to the low voltage and the first clock signal CLK1 transits to a high voltage, the transistors T2 and T6 are turned off. At this moment, the transistor T3 is sustained in a turned-off state because a next carry signal [Cout(i+1)] is sustained as the low voltage. When the transistor T2 is turned off, the junction J1 is disconnected from the set terminal S, thereby being floated.

Accordingly, the transistors T1 and T7 are sustained in a turned-on state. At this moment, the gate-off voltage Voff is applied to the junction J2 through the transistor T7. Accordingly, the transistors T4 and T5 are sustained in a turned-off state. Since all of the transistors T5 and T6 are turned off, the gate-off voltage Voff of the gate voltage terminal GV transferred to the junction J3 is interrupted. Since the transistor T1 is sustained in a turned-on state, only the gate-on voltage Von, which is the high voltage of the first clock signal CLK1, is transferred to the junction J3.

The capacitor C2 charges a voltage corresponding to the difference of the gate-on voltage Von and the gate-off voltage Voff. Since the capacitor C2 sustains a constant voltage, the voltage of the junction J3 rises to the gate-on voltage Von. As a result, the voltage of the floated junction J1 further rises as much as the gate-on voltage Von.

Due to parasitic capacitance occurring from the overlapping of the control terminal and the output terminal of the transistor T7, the voltage of the junction J1, which is the control terminal, increases. Then, the potential of the junction J2, which is the output terminal, also increases somewhat as shown. The capacitor C1 charges a voltage corresponding to the difference of the gate-on voltage Von that is a high voltage of the first clock signal CLK1 and the gate-off voltage Voff that is the voltage of a junction J2.

When the first clock signal CLK1 transits to the low voltage and the second clock signal CLK2 and the next carry signal [Cout(i+1)] transit to the high voltage, the transistors T3 and T6 are turned on. Since the previous carry signal [Cout(i−1)] is sustained as the low voltage, the transistor T2 is sustained in a turned-off state.

Since the transistor T3 is turned on, the gate-off voltage Voff is transferred to the junction J1 and the transistors T1 and T7 are turned off. When the transistor T7 is turned off, the junction J2 is floated. Since the capacitor C1 sustains a constant voltage at this moment, the first clock signal CLK1 transits to the low voltage. Accordingly, the voltage of the junction J2 further falls below the gate-off voltage Voff.

However, when the voltage of the junction 2 falls below the gate-off voltage Voff, the transistor T7 is turned on again and the gate-off voltage Voff is transferred to the junction J2. Therefore, the voltage of the junction J2 becomes almost identical to the gate-off voltage Voff in a final parallel state. Accordingly, the transistors T4 and T5 are continuously sustained in a turned-off state.

Since the transistor T1 is turned off and the transistor T6 is turned on, the gate-off voltage Voff of the gate voltage terminal GV is transferred and outputted to the junction J3, and the capacitor C2 is discharged.

After that, only the first and second clock signals CLK1 and CLK2 transit to the low voltage and the high voltage. However, the voltage level variation of the first clock signal CLK1 lifts the voltage of the junction J2 up to the gate-off voltage Voff, and the voltage level variation of the second clock signal CLK2 periodically turns the transistor T6 on and off. Therefore, the gate-off voltage Voff is periodically applied to the junction J3. Accordingly, the junction J3 continuously sustains the gate-off voltage Voff.

After the next carry signal [Cout(i+1)] transits to the low voltage and the transistor T3 is turned off, the junction J3 of an i-th stage [ST(i)] sustains the low voltage, that is, the gate-off voltage Voff, regardless of the first and second clock signals CLK1 and CLK2.

That is, when the first clock signal CLK1 is the high voltage and the second clock signal CLK2 is the low voltage, the voltage of the junction J2 rises because of the capacitor C1 so as to turn on the transistors T4 and T5. Accordingly, the gate-off voltage Voff is transferred to the junction J1 so as to sustain the transistors T1 and T7 in a turned-off state. Further, the gate-off voltage Voff is transferred to the junction J3 through the turned-on transistor T5.

When the first clock signal CLK1 is the low voltage and the second clock signal CLK2 is the high voltage, the voltage of the junction J2 falls because of the capacitor C1 so as to turn off the transistors T4 and T5. Accordingly, the junction J1 is floated. Therefore, the junction J1 sustains the low voltage, which is the previous voltage, by the capacitor C2 so as to sustain the transistors T1 and T7 in a turned-off state.

Also, the transistor T6 is turned on, and the gate-off voltage Voff is transferred to the junction J3. Although the first and second clock signals CLK1 and CLK2 change at predetermined periods later, the junction J3 constantly sustains the gate-off voltage Voff.

The image scanning driver 400 is supplied with the information for the image scanning signal lines based on the section information through a selection signal SEL. The selection signal SEL has information for determining output of image scanning signals from the respective stages to the corresponding image scanning signal lines G₁-Gₙ. The selection signal SEL has information to determine turning on or turning off the transistor T8. That is, the transistor T8 of each stage is turned on or turned off in accordance with the voltage level of the selection signal SEL. For example, when an image scanning signal line is included in the image change section, the voltage level of the selection signal SEL is the high voltage, i.e., the gate-on voltage Von. In contrast, when an image scanning signal line is not included in the image change section, the voltage level of the selection signal SEL is the low voltage, i.e., the gate-off voltage Voff.

For example, when an i-th pixel row is included in the image change section, the voltage level of the selection signal SEL has the gate-on voltage Von when a carry signal Cout(i) is changed into the gate-on voltage Von. The transistor T8 is turned on by the gate-on voltage Von of the selection signal SEL applied through the selection terminal SE, and thereby the gate-on voltage Von of the junction J3 is applied to the output terminal OUT though the turned-on transistor T8. As a result, a scanning signal of the gate-on voltage Von is applied to the i-th pixel row.

However, when the i-th pixel row is not included in the image change section, that is, the i-th pixel row is included in an image unchange section that is a section excluding the image change section, the voltage level of the selection signal SEL has the gate-off voltage Voff when the carry signal Cout(i) is changed into the gate-on voltage Von. The transistor T8 is turned off by the gate-off voltage Voff of the selection signal SEL applied through the selection terminal SE, and thereby the gate-on voltage Von of the junction J3 is not applied to the output terminal OUT.

The carry output terminal COUT outputs the voltage of the junction J3 to the reset terminal R of the previous stage [ST(i−1)] and the set terminal S of the next stage [ST(i+1)] regardless of the selection signal SEL. Thus, as shown in FIG. 9, the carry signals [Cout(1)-Cout(n)] sequentially output the high voltage after the scanning start signal STV1 is applied, and the image scanning outputs [Gout(1)-Gout(n)] output the high voltage only when the selection signal SEL has the high voltage.

Therefore, when portions of the current images are changed by comparing the current images and the previous images, the image scanning signals of the gate-on voltage Von are applied to the image scanning lines included in the image change section, such that only images in the image change section are changed.

Next, an example of the image scanning driver according to another exemplary embodiment of the present invention will be described with reference to FIGS. 5, 7, and 10.

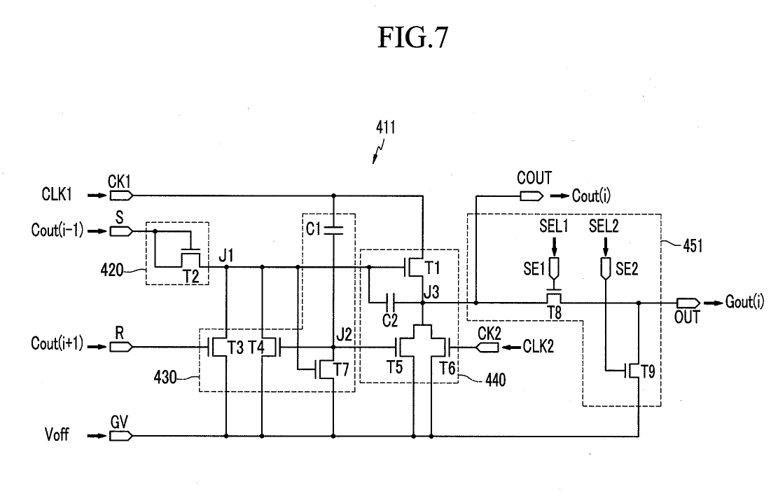

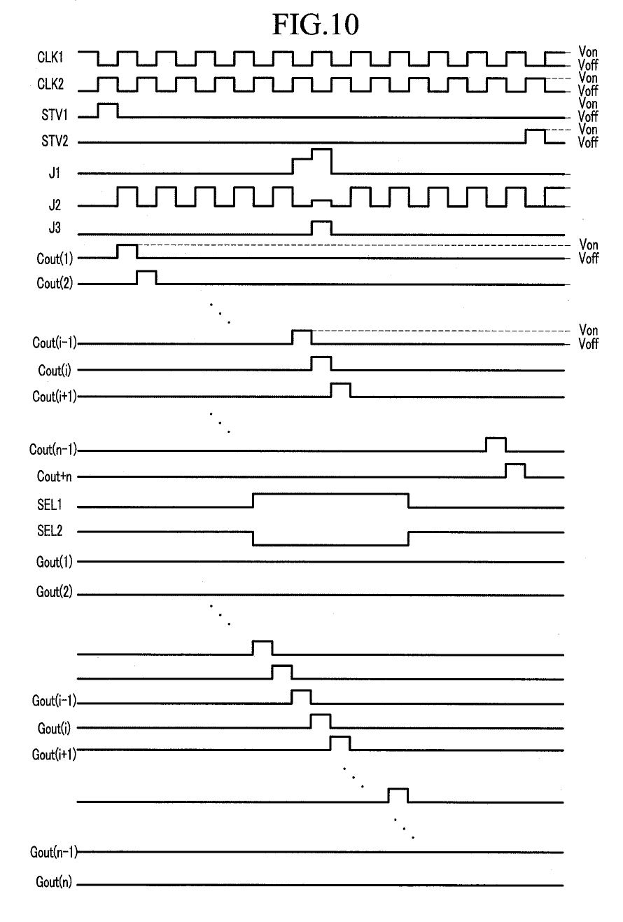

FIG. 5 is a block diagram of another example of an image scanning driver according to an exemplary embodiment of the present invention, FIG. 7 is a circuit diagram of an example of an i-th stage of a shift register for the image scanning driver shown in FIG. 5, and FIG. 10 is a signal waveform of signals for driving the image scanning driver shown in FIG. 5.

As shown in FIG. 5, an image scanning driver 401 is a shift register including a plurality of stages 411, each of which is connected to one of the image scanning lines G₁ to Gₙ. The image scanning driver 401 receives scanning start signals STV1 and STV2, clock signals CLK1 and CLK2, selection signals SEL1 and SEL2, and a gate-off voltage Voff.

Each of the stages 411 includes a set terminal S, a reset terminal R, a gate voltage terminal GV, an output terminal OUT, clock terminals CK1 and CK2, selection terminals SE1 and SE2, and a carry output terminal COUT.

The stages 411 of the image scanning driver 401 are substantially the same as the stages 410 of the image scanning driver 400 shown in FIGS. 4 and 6, except for the selection terminals SE1 and SE2. That is, the number of selection terminals SE of each stage 410 of the image scanning driver 400 is one, while the number of selection terminals SE1 and SE2 of each stage 411 of the image scanning driver 401 is two. The elements performing the same operations are indicated with the same reference numerals, and detailed descriptions thereof are omitted.

The selection terminals SE1 and SE2 are supplied with selection signals SEL1 and SEL2, respectively. Each of the stages 411 generates a carry signal [Cout(i)] based on a carry signal [Cout(i−1)] of a previous stage [ST(i−1)] and a carry signal [Cout(i+1)] of the next stage [ST(i+1)], in synchronization with clock signals CLK1 and CLK2. In addition, each of the stages 411 determines to output an image scanning output [Gout(i)] based on the selection signal SEL1 or SEL1.

The selection signals SEL1 and SEL2 have a phase difference of about 180°.

For example, if a selection signal SEL1 of a high voltage is input to a selection terminal SE1 of an i-th stage [ST(i)], a selection signal SEL2 of a low voltage is input to a selection terminal SE2 of an i-th stage [ST(i)]. In contrast, if a selection signal SEL1 of the low voltage is input to a selection terminal SE1 of an i-th stage [ST(i)], a selection signal SEL2 of the high voltage is input to a selection terminal SE2 of an i-th stage [ST(i)].

Referring to FIG. 7, each of the stages 411 of the image scanning driver 401 according to this example, for example an i-th stage, includes a first input unit 420, a second input unit 430, an output voltage generator 440, and an output determiner 451. Each of the constituent elements includes at least one of N channel field effect transistors T1 to T8.

The first input unit 420, the second input unit 430, and the output voltage generator 440 are substantially the same as those of each stage 410 of the image scanning driver 400 shown in FIG. 6, and therefore descriptions of the units 420 and 430 and the generator 440 are omitted.

The output determiner 451 includes a transistor T8 connected between an output terminal OUT and a junction J3, and a transistor T9 connected to the output terminal OUT and a gate voltage terminal GV. The transistor T8 includes a control terminal connected to the selection terminal SE1, and transmits a voltage of the junction J3 to the output terminal OUT connected to the image scanning lines G₁ to Gₙ, when a selection signal SEL1 has a high voltage. The transistor T9 includes a control terminal connected to the selection terminal SE2, and transmits the gate-off voltage Voff to the output terminal OUT connected to the image scanning lines G₁ to G₁, when a selection signal SEL2 has the high voltage.

Hereinafter, the operation of the shift register shown in FIG. 7 will be described with reference to FIG. 10. Each stage 411 according to this example is substantially the same as the stage 410, except that the output determiner 451 further includes the transistor T9, and detailed descriptions of the same elements are omitted.

The selection signal SEL2 has information to determine turning on or turning off the transistor T9.

For example, when an image scanning signal line is included in an image change section, the voltage level of the selection signal SEL2 is a low voltage, i.e., the gate-off voltage Voff. In contrast, when an image scanning signal line is not included in the image change section, the voltage level of the selection signal SEL2 is a high voltage, i.e., the gate-on voltage Von.

For, example, when an i-th pixel row is included in the image change section, the voltage level of the selection signal SEL2 has the gate-off voltage Voff when a carry signal Cout(i) is changed into the gate-on voltage Von. The transistor T9 is turned off by the gate-off voltage Voff of the selection signal SEL2 applied through the selection terminal SE2, and thereby the gate-off voltage Voff is not transmitted to the output terminal OUT.

However, when an i-th pixel row is included in an image unchange section, the voltage level of the selection signal SEL2 has the gate-on voltage Von when a carry signal Cout(i) is changed into the gate-on voltage Von. The transistor T9 is turned on by the gate-on voltage Von of the selection signal SEL2 applied through the selection terminal SE2, and thereby the gate-off voltage Von of the gate voltage terminal GV is applied to the output terminal OUT though the turned on transistor T9. As a result, a scanning signal of the gate-off voltage Voff is applied to the i-th pixel row.

As shown in FIG. 10, the selection signal SEL2 and the selection signal SEL1 has a phase difference of 180°, and image scanning lines not included in the image change section are supplied with the gate-off voltage Voff. Since each of the stages 411 of this example further includes the selection terminal SE2, the image scanning lines not included in the image change section are exactly supplied with the gate-off voltage Voff.

In the stage 410 shown in FIG. 6, image scanning signal lines G₁-Gₙ that are included in the image change section are supplied with the gate-on voltage Von, but no image scanning signal lines G₁-Gₙ that are included in the image unchange section are supplied with a voltage, in accordance with the voltage level of the selection signal SE.

However, the image scanning lines G₁-Gₙ are connected to capacitance loads, and thereby when a voltage is not transmitted to the image scanning lines G₁-Gₙ, the image scanning lines G₁-Gₙ that are not supplied with the voltage may have a voltage variation due to the surroundings as compared with the image scanning lines G₁-Gₙ that are supplied with the voltage. That is, the capacitance loads connected to the image scanning lines G₁-Gₙ that are not supplied with the voltage, i.e., voltages of pixel electrodes, may be varied due to noise. Thus, the image scanning lines G₁-Gₙ that are not included in the image change section should be supplied with the gate-off voltage Voff for decreasing the voltage variation of the pixel electrodes due to the surroundings. Thereby, in this example of the embodiment, since each of stages 411 transmits the gate-off voltage Voff to the image scanning lines G₁-Gₙ that are not included in the image change section using the selection signal SEL1 through the terminal SE2, the voltage variation of the pixel electrodes due to the surroundings decreases and image quality improves.

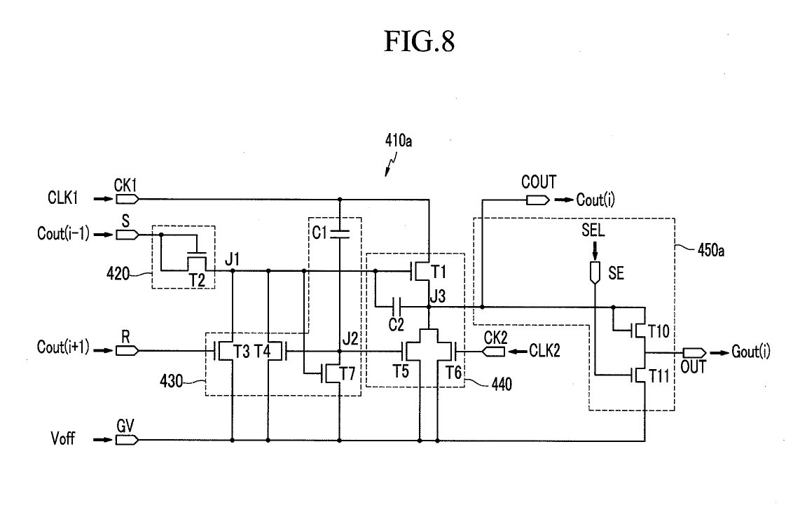

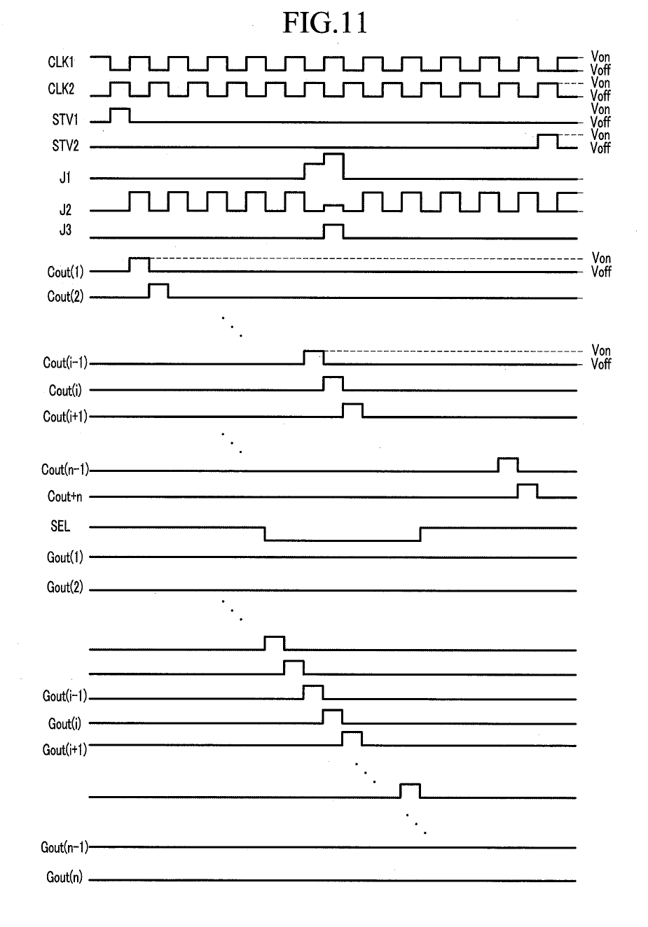

Next, referring to FIGS. 8 and 11, another example of the stage of the shifter register of the image scanning driver shown in FIG. 4 will be described.

FIG. 8 is a circuit diagram of another example of an i-th stage of a shift register for the image scanning driver shown in FIG. 4, and FIG. 11 is a signal waveform of signals for driving an image scanning driver having the shift register shown in FIG. 8.

Referring to FIG. 8, each of the stages 410a of the image scanning driver according to this example, for example an i-th stage, includes a first input unit 420, a second input unit 430, an output voltage generator 440, and an output determiner 450a. The first input unit 420, the second input unit 430, and the output voltage generator 440 of each stage 410a are substantially the same as those of the stage 410 shown in FIG. 6, and thereby detailed descriptions of the elements 420, 430, and 440 are omitted.

The output determiner 450a includes a transistor T10 connected between an output terminal OUT and a junction J3, and a transistor T11 connected between the output terminal OUT and a gate voltage terminal GV. The transistor T10 includes an input terminal and a control terminal, which are commonly connected to the junction J3, and functions as a diode. The transistor T10 outputs a gate-on voltage Von, which is a high voltage when the junction J3 has a high voltage. The transistor T11 includes a control terminal connected to the selection terminal SE, and outputs a gate-off voltage Voff, which is a low voltage when the selection signal SEL has a high voltage.

The operation of the stage 410a shown in FIG. 8 will be described with reference to FIG. 11. The stage 410a according to this example is substantially the same as the stage 410 shown in FIG. 5 except for the output determiner 450a, and thereby elements performing the same operations are indicated with the same reference numerals, and detailed descriptions thereof are omitted.

The selection signal SEL has information to determine turning on or turning off the transistor T11. When an image scanning signal line is included in an image unchange section, the image scanning signal line has a gate-on voltage Von, that is, a high voltage.

For, example, when an i-th pixel row is included in the image change section, the voltage level of the selection signal SEL has the gate-off voltage Voff when a carry signal Cout(i) is changed into the gate-on voltage Von. The transistor T11 is turned off by the gate-off voltage Voff of the selection signal SEL applied through the selection terminal SE, and thereby the gate-off voltage Voff of the gate voltage terminal GV is not transmitted to the output terminal OUT. At this time, a carry signal Cout(i) has a voltage level of the gate-on voltage Von, and the carry signal Cout(i) is input to a control terminal of the transistor T10. Thereby, the transistor T10 is turned on by the carry signal Cout(i) of the gate-on voltage Von and the gate on voltage Von is output to the output terminal OUT through the turned-on transistor T10. Thus, the gate-on voltage Von is transmitted to the image scanning line of the i-th pixel row.

In contrast, when the i-th pixel row is not included in the image change section, the voltage level of the selection signal SEL has the gate-on voltage Von when a carry signal Cout(i) is changed into the gate-on voltage Von. The transistor T11 is turned on by the selection signal SEL of the high voltage applied through the selection terminal SE, and thereby the gate-off voltage Voff of the gate voltage terminal GV transmits to the output terminal OUT.

As shown in FIG. 11, the selection signal SEL applies the gate-off voltage Voff in the image change section, but applies the gate-on voltage Vo in the image unchange section. As described above, in the stage 411 shown in FIG. 7, the gate-on voltage Von is transmitted to the output terminal OUT by the selection signal SELL in the image change section, and the gate-off voltage Voff is transmitted to the output terminal OUT by the selection signal SEL2 in the image unchange section. However, in the stage 410a shown in FIG. 8, using one selection signal SEL, the gate-on voltage Von is transmitted to the output terminal OUT in the image change section, and the gate-off voltage Voff is transmitted to the output terminal OUT in the image unchange section.

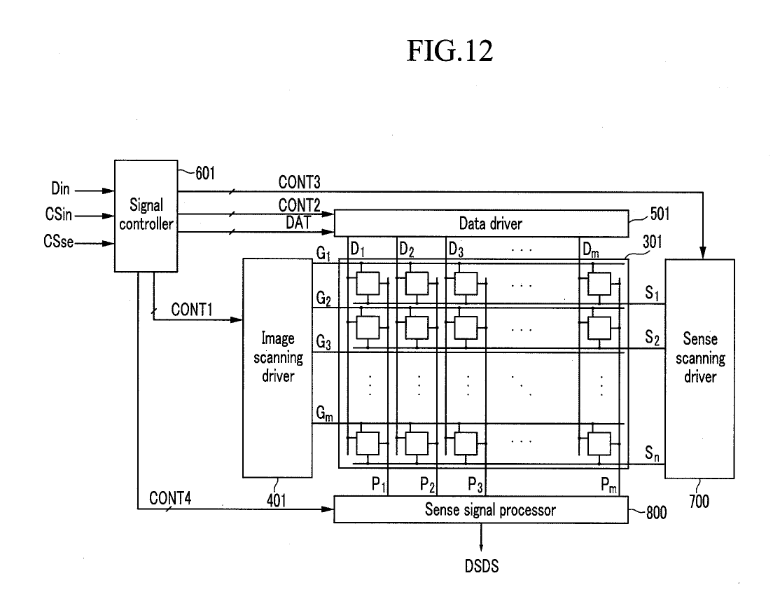

An electrophoretic display according to another embodiment of the present invention will be described with reference to FIGS. 12 to 14. The electrophoretic display of this embodiment may perform a sensing operation only in portions of the entire screen.

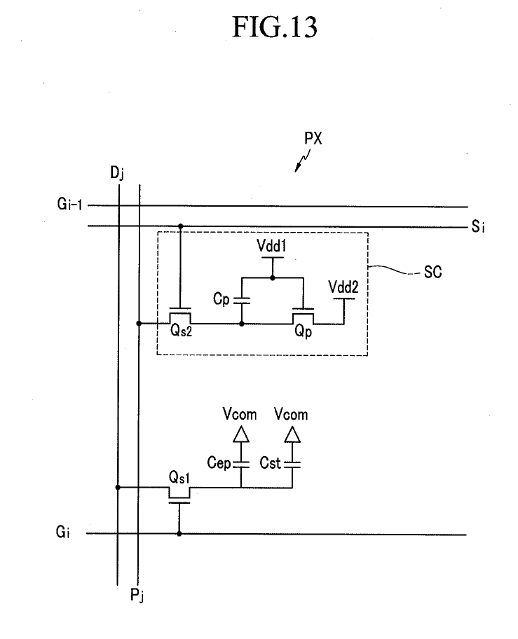

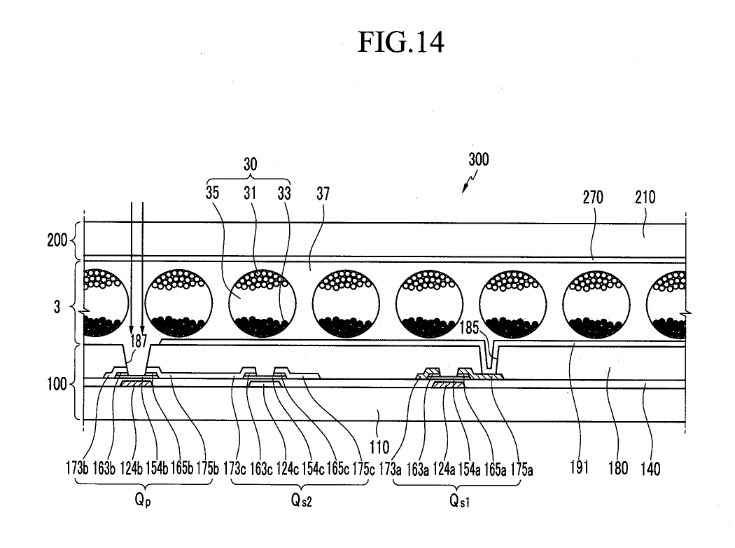

FIG. 12 is a block diagram of an electrophoretic display device according to this exemplary embodiment of the present invention, FIG. 13 is an equivalent circuit diagram of a pixel in an electrophoretic display device according to this exemplary embodiment of the present invention, and FIG. 14 is a cross-sectional view of an electrophoretic panel assembly of an electrophoretic display device according to this exemplary embodiment of the present invention.

Referring to FIG. 12, the electrophoretic display according to another exemplary embodiment of the present invention includes an electrophoretic panel assembly 301, an image scanning driver 401, a data driver 501, a signal controller 601, a sense scanning driver 700, and a sense signal processor 800.

As compared with the electrophoretic panel assembly 300, the electrophoretic panel assembly 301 according to this embodiment further includes a plurality of sensing units SC in a plurality of pixels PX, respectively, to perform a sensing operation, as shown in FIG. 13. The image scanning driver 401 and the data driver 501 of this embodiment are substantially the same as the image scanning driver 400 and the data driver 500 shown in FIG. 1, respectively, and therefore detailed descriptions of the image scanning driver 401 and the data driver 501 are omitted. Hereinafter, only portions that are different from the electrophoretic display shown in FIG. 1 will be described.

Referring to FIGS. 12 and 13, the electrophoretic panel assembly 301 includes a plurality of display signal lines G₁-Gₙ and D₁-Dₘ, a plurality of sense signal lines S₁-Sₙ and P₁-Pₘ, and the plurality of pixels PX and the plurality of sensing units SC, which are arranged basically in a matrix pattern.

The sensing signal lines S₁-Sₙ and P₁-Pₘ are formed on the insulation substrate 110, and include a plurality of sense scanning lines S₁-Sₙ for transmitting a sense scanning signal, and a plurality of sense data lines P₁-Pₘ for transmitting a sense data signal. The sense scanning lines S₁-Sₙ extend substantially in a row direction to run almost parallel to each other, and the sense data lines P₁-Pₘ extend substantially in a column direction to run almost parallel to each other.

As shown in FIGS. 13 and 14, each of the sensing units SC, for example a sensing unit SC connected to an i-th sense scanning line Si and a j-th sense data line Pj, includes a sensing element Qp, a switching element Qs2, and a sense capacitor Cp, where i=1, 2, . . . , n and j=1, 2, . . . , m. The sensing units SC are formed on the lower panel 100 and are mostly covered by the passivation layer 180.

The sensing element Qp is a three terminal element such as a thin film transistor. The sensing element Qp includes a control terminal 124b connected to a sensing control voltage Vdd1, an output terminal 175b connected to one end of a capacitor Cp and an input terminal 173c of a switching element Qs2, and an input terminal 173b connected to a sensing input voltage Vdd2. The sensing element Qp further includes a semiconductor 154b formed between a control terminal 124b and an input terminal 173b and between a control terminal 124b and an output terminal 175b, and ohmic contacts 163b and 165b formed on the semiconductor 154b. When light is radiated to the semiconductor 154b of the sensing element Qp through an exposure hole 187 formed on the passivation layer 180, an optical current is formed. The optical current flows to the sensing capacitor Cp and the switching element Qs2 by a voltage difference between the input terminal 173b and the output terminal 175b.

The sensing capacitor Cp includes one end connected to a sensing control voltage Vdd1 and the other end connected to an output terminal 175b of a sensing element Qp and an input terminal 173c of a switching element Qs2. The sensing capacitor Cp accumulates a charge according to an optical current from the sensing element Qp to sustain a predetermined voltage.

Also, the switching element Qs2 is a three terminal element such as a thin film transistor. The switching element Qs2 includes a control terminal 124c connected to a sense scanning line Si, an output terminal 175c connected to a sense data line Pj, and an input terminal 173c connected to an output terminal 175b of a sensing element Qp. The switching element Qs2 further includes a semiconductor 154c formed between a control terminal 124c and an input terminal 173c and between a control terminal 124c and an output terminal 175c, and ohmic contacts 163c and 165c formed on the semiconductor 154c. The switching element Qs2 outputs a voltage stored in a sensing capacitor Cp or an optical current from a sensing element Qp to a sense data line Pj as a sense data signal when a sense scanning signal is applied.

The semiconductors 154a, 154c, and 154b of the switching elements Qs1 and Qs2 and the sensing element Qp may be formed of an amorphous silicon or polysilicon thin film transistor. The ohmic contacts 163a, 163b, 163c, 165a, 165b, and 165c may be made of n+ hydrogenated a-Si heavily doped with an N-type impurity, or they may be made of silicide. The control terminals 124b and 124c and the semiconductors 154b and 154c of the switching element Qs2 and the sensing element Qp are insulated from each others by a gate insulating layer 140 made of silicon nitride (SiNx).

Although the pixels PX and the sensing units SC are described to be identical in number, the number of sensing units SC may be smaller than the number of pixels PX. Accordingly, the number of sense scanning lines S₁-Sₙ and sense data lines P₁-Pₘ may be variable.

For example, in some embodiments, the resolution of the electrophoretic display device is equivalent to QVGA (quarter video graphics array) having 240×320 dots, with each dot corresponding to three pixels PX. When the resolution of the sensing units SC is equivalent to QVGA, one sensing unit SC is assigned to every three pixels PX. When the resolution of the sensing units SC is equivalent to QQVGA (quarter QVGA) having 120×160 dots, one sensing unit SC is assigned to every twelve pixels PX. Here, one dot is a basic unit for representing a color and includes a set of three pixels, for example red, green, and blue pixels.

The sense scanning driver 700 is connected to the sense scanning lines S₁-Sₙ, and applies a sense scanning signal to the sense scanning lines S₁-Sₙ. A voltage for turning on the switching elements Gs2 and a voltage for turning off the switching elements Gs2 are synthesized to generate a sense scanning signal. The sense scanning driver 700 may be integrated into the panel assembly 301 along with the signal lines S₁-Sₙ and P₁-Pₘ, the switching elements Qs2, and the sensing units SC. Alternatively, the sense scanning driver 700 and the sense signal processor 800 may include at least one integrated circuit (IC) chip mounted on the panel assembly 301 or on a flexible printed circuit (FPC) film in a tape carrier package (TCP) type, which are attached to the panel assembly 301.

The sense signal processor 800 is connected to the sense data lines (P₁-Pₘ) of the electrophoretic panel assembly 301, and receives sense data signals from the sense data lines P₁-Pₘ.

The signal controller 600 controls the image scanning driver 401, the data driver 501, the sense scanning driver 700, and the sense signal processor 800 in accordance with control signals (not shown).

Hereinafter, the optical sense operation of the above electrophoretic display device will be described in detail.

The signal controller 600 receives input image signals Din, input control signals CSin, and sense input control signals CSse.

The signal controller 601 appropriately processes the input image signals Din to be suitable for the operation of the electrophoretic panel assembly 301 based on the image input control signals CSin and the sense input control signals CSse, and generates gate control signals CONT1, data control signals CONT2, sense scanning control signals CONT3, sense control signals CONT4, and output image signals DAT. Then, the signal controller 601 transmits the gate control signals CONT1 to the image scanning driver 401, the data control signals CONT2 and the output image signals DAT to the data driver 501, and the sense scanning control signals CONT3 to the sense scanning driver 700. The signal controller 601 transmits the sense control signals CONT4 to the sense signal processor 800.

The sense scanning control signals CONT3 include a scanning start signal for instructing to start scanning of a sense scanning signal, at least one clock signal for controlling the output of the sense scanning signal, and a selection signal.

The sense scanning driver 700 receives the sense scanning control signals CONT3 from the signal controller 601, and the scanning control signals CONT3 includes information about a section for performing a sensing operation on one screen. That is, when the electrophoretic display device determines operation states of all the sensing units SC on the electrophoretic panel assembly 301, the sense scanning driver 700 sequentially applies a sense scanning signal to all the sense scanning lines S₁-Sₙ to turn on the switching elements Qs2 connected to the scanning lines S₁-Sₙ based on the sense scanning control signals CONT3. On the contrary, when the electrophoretic display device determines operation states of portions of the sensing units SC on the electrophoretic panel assembly 301, the sense scanning driver 700 applies a sense scanning signal to the portions, for example Sₖ-Sₙ of the sense scanning lines S₁-Sₙ, to turn on the switching elements Qs2 connected to the scanning lines Sₖ-Sₙ, by the controlling of the sense scanning control signals CONT3. Thus, the sense data lines P₁-Pₘ transmit sense data signals from the sensing units SC to the sense signal processor 800.

After amplifying or filtering the received sense data signals in accordance with the sense control signals CONT4, the sense signal processor 800 converts the processed sense data signals into digital sense data signals DSDS to transmit to a contact position determiner (not shown). The contact position determiner determines a contact position based on the digital sense data signals DSDS to output contact information such as the contact position to an external device. The input image signals Din may be input to the signal controller 601 based on the contact information.

In FIG. 13, a sense input voltage Vdd2 may be the same as the gate-off voltage Voff.

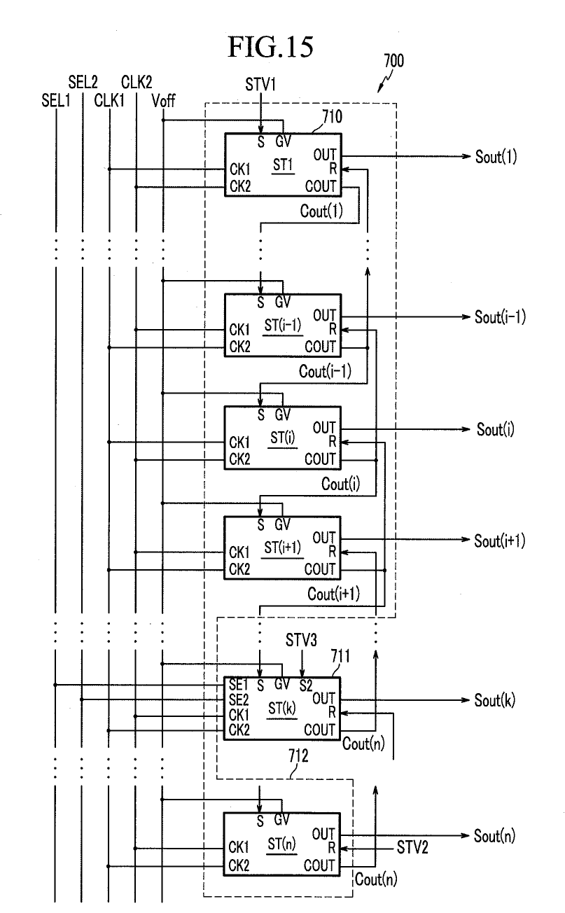

Next, the sense scanning driver 700 of the electrophoretic display device according to this embodiment will be described with reference to FIGS. 15, 16, 17, and 18.

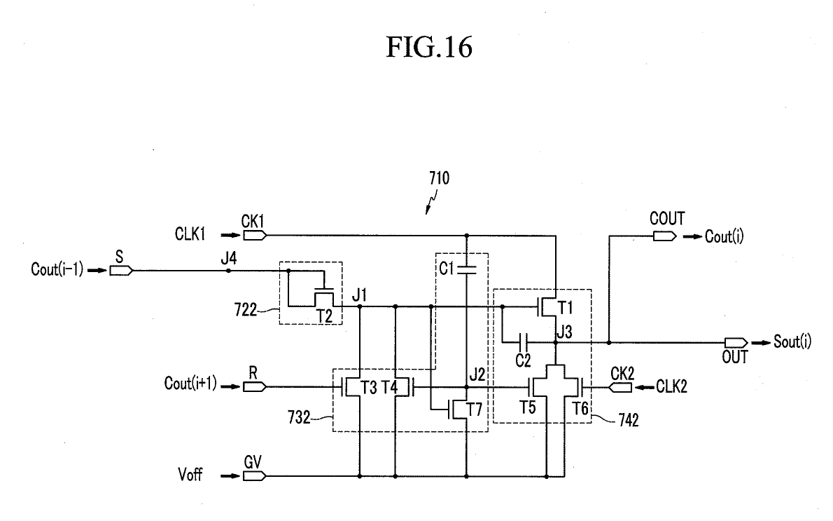

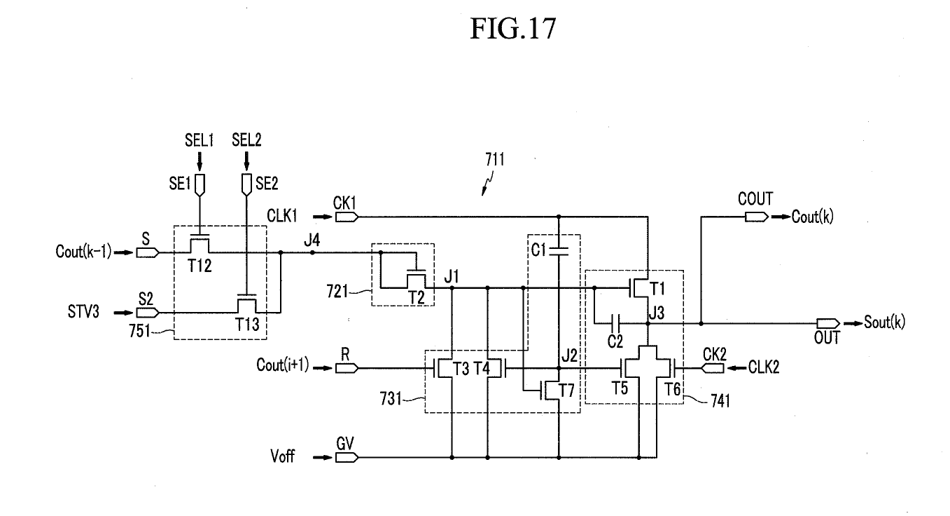

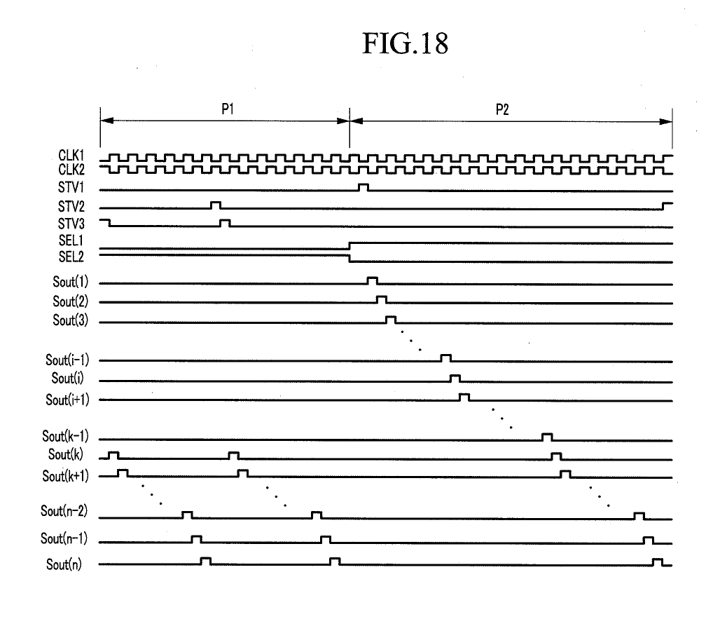

FIG. 15 is a block diagram of a sense scanning driver according to an exemplary embodiment of the present invention, FIG. 16 is a circuit diagram of an i-th stage of a shift register for the sense scanning driver shown in FIG. 15, FIG. 17 is a circuit diagram of a k-th stage of a shift register for the sense scanning driver shown in FIG. 15, and FIG. 18 is a signal waveform of signals for driving the sense scanning driver shown in FIG. 15.

Referring to FIG. 15, the sense scanning driver 700 is a shift register including a plurality of stages 710, each of which is connected to one of the sense scanning lines S₁ to Sₙ, and a stage 711 that is different from the stages 710. The sense scanning driver 700 receives sense scanning start signals STV1, STV2, and STV3, clock signals CLK1 and CLK2, selection signals SEL1 and SEL2, and a gate-off voltage Voff.

In this embodiment, it is assumed that one stage 711 is a k-th stage of the sense scanning driver 700. The stage 711 includes set terminals S and S2, a reset terminal R, a gate voltage terminal GV, an output terminal OUT, clock terminals CK1 and CK2, selection terminals SE1 and SE2, and a carry output terminal COUT. Further, each of the remaining stages 712 of the sense scanning driver 700 includes a set terminal S, a reset terminal R, a gate voltage terminal GV, an output terminal OUT, clock terminals CK1 and CK2, and a carry output terminal COUT, excluding the set terminal S2 and selection terminals SE1 and SE2.

FIG. 16 shows a circuit diagram of a stage 710 of the remaining stages 712. In each of the stages 710, for example an i-th stage [ST(i)], the set terminal S receives a carry signal [Cout(i−1)] of a previous stage [ST(i−1)], the reset terminal R receives a carry signal [Cout(i+1)] of the next stage [ST(i+1)], and the clock terminals CK1 and CK2 receive clock signals CLK1 and CLK2. The output terminal OUT1 outputs an sense scanning output [Sout(i)] to a sense scanning line Sᵢ. The carry output terminal COUT outputs a carry signal [Cout(i)] to the previous stage [ST(i−1)] and the next stage [ST(i+1)]. Herein, the carry signal may be the same as the sense scanning output [Sout(i)].

However, as shown in FIG. 17, in the k-th stage [ST(k)] 711, the set terminal S receives a carry signal [Cout(k−1)] of a previous stage [ST(k−1)], the set terminal S1 receives a scanning start signal STV3, the reset terminal R receives a carry signal [Cout(k+1)] of the next stage [ST(k+1)], and the clock terminals CK1 and CK2 receive clock signals CLK1 and CLK2. The output terminal OUT1 outputs a sense scanning output [Sout(k)] to a sense scanning line Sₖ. The carry output terminal COUT outputs a carry signal [Cout(k)] to the previous stage [ST(k−1)] and the next stage [ST(k+1)]. Herein, the carry signal may be the same as the sense scanning output [Sout(i)]. Also, the selection terminals SE1 and SE2 receive selection signals SEL1 and SEL2, respectively.

Therefore, the sense scanning driver 700 includes the plurality of stages 710 and the stage 711. Each of the stages 710 generates a carry signal [Cout(i)] based on a carry signal [Cout(i−1)] of a previous stage [ST(i−1)] and a carry signal [Cout(i+1)] of the next stage [ST(i+1)], in synchronization with the clock signals CLK1 and CLK2, and outputs a sense scanning output [Sout(i)] to a sense scanning line.

However, the k-th stage 711 includes two selection terminals and receives the carry signal [Cout(k−1)] from the previous stage [ST(k−1)] or the scanning start signal STV3 through one of two set terminals S and S2. That is, the k-th stage 711 generates a carry signal [Cout(k)] based on a carry signal [Cout(k−1)] of a previous stage [ST(k−1)] or a carry signal [Cout(k+1)] of the next stage [ST(k+1)], in synchronization with the clock signals CLK1 and CLK2, and outputs a sense scanning output [Sout(k)] to a sense scanning line.

When determining operation states of all the sensing units SC, the first stage [ST1] receives a scanning start signal STV1 through the set terminal S to sequentially output from the first sense scanning output Sout(1) to the last sense scanning output Sout(n). In addition, the last stage [ST(n)] receives a scanning start signal STV2 through the reset terminal R since no carry signal from the next stage exists.

However, when determining operation states of portions Sₖ-Sₙ of all the sensing units SC, the K-th stage [ST(k)] 711 receives a scanning start signal STV3 through the set terminal S2, such that a k-th sense scanning output Sout(k) through to the last sense scanning output Sout(n) are sequentially output.

The clock signals CLK1 and CLK2 have a duty ratio of about 50% and a phase difference of about 180°. When a clock signal CLK1 is input to a clock terminal CK1 and a clock signal CLK2 is input to a clock terminal CK2 in an i-th stage [ST(i)], a clock signal CLK2 is input to a clock terminal CK1 and a clock signal CLK1 is input to a clock terminal CK2 in adjacent (i−1)-th and (i+1)-th stages [ST(i−1) and ST(i+1)].

Referring to FIG. 16, each of the stages 710, for example an i-th stage, includes a first input unit 722, a second input unit 732, and an output voltage generator 742.

The first input unit 722, the second input unit 732, and the output voltage generator 742 of the stage 710 are substantially the same as the first input unit 420, the second input unit 430, and the output voltage generator 440 of the stage 410 of the image scanning driver 400 shown in FIG. 6, respectively, and thereby detailed descriptions thereof are omitted.

As compared with the stage 410 shown in FIG. 10, the stage 710 of the sense scanning driver 700 does not includes the output determiner 450.

Thus, the stage 710 unconditionally outputs a sense scanning output [Sout(i)] to a corresponding sense scanning line Sᵢ based on a carry signal [Cout(i−1)] of the previous stage [ST(i−1)] without output determination.

Referring to FIG. 17, the k-th stage 711 includes a first input unit 721, a second input unit 731, an output voltage generator 741, and an input signal determiner 751. The first input unit 721, the second input unit 731, and the output voltage generator 741 of the stage 711 are substantially the same as the first input unit 420, the second input unit 430, and the output voltage generator 440 of the stage 410 of the image scanning driver 400 shown in FIG. 6, respectively, and thereby detailed descriptions thereof are omitted.

The input signal determiner 751 includes a transistor T12 connected to a set terminal S, and a junction J4 and a transistor T11 connected to a set terminal S2 and the junction J4. The transistor T11 includes a control terminal connected to the selection terminal SE1. When the selection signal SEL1 has a high level, the transistor T11 transmits a carry signal [Cout(k−1)] of a previous stage [ST(k−1)] applied through the set terminal S to the junction J4. The transistor T13 includes a control terminal connected to the selection terminal SE2. When the selection signal SEL2 has a high level, the transistor T13 transmits a scanning start signal STV3 from the set terminal S2 to the junction J4.

In comparison with the stage 710, the k-th stage 711 further includes the input signal determiner 751. Thereby, as described above, the k-th stage 711 generates a carry signal [Cout(k)] based on a carry signal [Cout(k−1)] of a previous stage [ST(k−1)] or a carry signal [Cout(k+1)] of the next stage [ST(k+1)], in synchronization with the clock signals CLK1 and CLK2, and outputs a sense scanning output [Sout(k)] to a sense scanning line. That is, the k-th stage 711 outputs the sense scanning output [Sout(k)] to the sense scanning line Sₖ based on the carry signal [Cout(k−1)] of the previous stage [ST(k−1)] or the scanning start signal STV3. In addition, the next stages 710 after the k-th stage 711 sequentially output sense scanning outputs based on carry signals of previous stages to sense scanning lines Sₖ₊₁ to Sₙ.

That is, when determining operation states of all the sensing units SC, the k-th stage 711 receives a carry signal [Cout(i−1)] of a previous stage [ST(i−1)] and then outputs a sense scanning output [Sout(k)] to a sense scanning line Sₖ and transmits a carry signal [Cout(k)] to the next stage [ST(k+1)]. However, when determining operation states of portions Sₖ-Sₙ of all the sensing units SC, the k-th stage 711 receives a scanning start signal STV3, and then outputs a sense scanning output [Sout(k)] to a sense scanning line Sₖ and transmits a carry signal [Cout(k)] to the next stage [ST(k+1)]. Therefore, when determining operation states of portions Sₖ-Sₙ of all the sensing units SC, only the sense scanning outputs [Sout(k)-Sout(n)] from the K-th stage 711 to the next stages 710 thereof are output to the sense scanning lines Sₖ-Sₙ.

Referring to FIG. 18, an operation of the stage 710 will be described in detail.

A period P1 of FIG. 18 represents a signal waveform when determining operation states of the portions Sₖ-Sₙ of all the sensing units SC, while a period P2 of FIG. 18 represents a signal waveform when determining operation states of all the sensing units SC. FIG. 18 shows signal waveforms of the clock signals CLK1 and CLK2, the scanning start signals STV1, STV2, and STV3, the selection signals SEL1 and SEL2, and the sense scanning outputs [Sout(1)-Sout(n)] applied to the scanning lines S₁-S₁.

When determining operation states of the portions Sₖ-Sₙ of all the sensing units SC (P1), the scanning start signal STV3 of a high level is applied to the set terminal S2 of the k-th stage [ST(k)]. Thus, the k-th stage [ST(k)] outputs the sense scanning output [Sout(k)] of a high level to the sense scanning line Sₖ, and then the stages 710 after the k-th stage [ST(k)] sequentially output the sense scanning outputs [Sout(k+1)-Sout(n)] of the high level to the sense scanning lines Sₖ₊₁-Sₙ until the scanning start signal STV2 of the high level is applied to the reset terminal R of the last stage [ST(n)]. At this time, since the k-th stage 711 outputs the sense scanning output [Sout(k)] to the sense scanning line Sₖ in synchronization with the input of the scanning start signal STV3, the input signal determiner 751 of the K-th stage 711 should transmit the scanning start signal STV3 to the junction J4 of the k-th stage 711.

For this, the transistor T13 connected to the set terminal S2 supplied with the scanning start signal STV3 of the high level and the junction J4 should be in a turned-on state, and for turning on the transistor T13, the selection signal SEL2 should be a high level. However, the transistor T12 connected to the set terminal S supplied with the carry signal [Cout(k−1)] from the previous stage [ST(k−1)] and the junction J4 should be in a turned-off state, and the selection signal SEL1 should be a high level.

When determining operation states of all the sensing units SC (P2), the scanning start signal STV1 of a high level is applied to the set terminal S of the first stage [ST1]. Thereby, the first stage [ST1] outputs a sense scanning output [Sout1] of the high level to the sense scanning line S1, and then the stages 710 after the first stage [ST1] sequentially output the sense scanning outputs [Sout(2)-Sout(n)] of the high level to the sense scanning lines S₂-Sₙ until the scanning start signal STV2 of the high level is applied to the reset terminal R of the last stage [ST(n)]. At this time, since the k-th stage 711 outputs a sense scanning output [Sout(k)] to the sense scanning line Sk in synchronization with a carry signal [Cout(k−1)] from a previous stage [ST(k−1)], the input signal determiner 751 of the k-th stage 711 should transmit the carry signal [Cout(k−1)] to the junction J4 of the k-th stage 711.

Thereby, the transistor T12 is connected for transmitting the carry signal [Cout(k−1)] of the previous stage [ST(k−1)] to the junction J4 in a turned-on state, and for turning on the transistor T12, the selection signal SEL1 should be the high level. However, the transistor T13 connected to the set terminal S2 supplied with the scanning start signal STV3 and the junction J4 should be in a turned-off state, and the selection signal SEL2 should be the low level.

Therefore, when the sensing operation is performed on a portion of the entire screen by determining operation states of the portions Sₖ-Sₙ of all the sensing units SC, the sensing operation is performed only on portions supplied with the sense scanning outputs [Sout(k)-Sout(n)] of the high level through the sense scanning lines Sₖ-Sₙ. In addition, after the sensing operation is performed on a portion of the entire screen, when the sensing operation is performed on the entire screen, all the stages 710 and 711 sequentially output the sense scanning outputs [Sout 1-Sout(n)] of the high level to all the sense scanning lines S₁-Sₙ.

As described above, the electrophoretic display device according to this embodiment is capable of displaying changed images on portions of the entire screen, and is also capable of performing sensing operation on portions of the entire screen. That is, according to the exemplary embodiment, the image scanning signals and the sense scanning signals are applied only to portions of the entire screen.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel assembly that includes a plurality of pixels and a plurality of signal lines connected to the pixels; and
a driver comprising a plurality of stages connected with one another for sequentially generating output signals in synchronization with a plurality of clock signals,
wherein portions of the plurality of stages output the output signals to the display panel assembly.

2. The display device of claim 1, wherein the driver comprises an image scanning driver that applies image scanning signals to the signal lines, and each of the plurality of stages comprises:
an first input unit that outputs a first voltage in response to one of the output signals from a previous stage or a scanning start signal;
a second input unit that outputs a second voltage in response to one of the plurality of clock signals or one of output signals from a next stage;
an output voltage generator to charge the first voltage and to generate the output signal in response to the output signals from the first input unit and the second input unit; and
an output determiner that determines whether the output signal from the output voltage generator is output to the display panel assembly.

3. The display device of claim 2, wherein each of the plurality of stages comprises a first selection terminal, and the output determiner determines whether the output signal outputs to the display panel assembly based on a first selection signal that is applied to the first selection terminal.

4. The display device of claim 3, wherein the output determiner comprises a first transistor including a first terminal, a second terminal, and a control terminal, and
wherein the first terminal is connected to the output voltage generator, the second terminal is connected to the output terminal, and the control terminal is connected to the first selection terminal.

5. The display device of claim 4, wherein:
each of the plurality of stages further comprises a set terminal, a reset terminal, and first and second clock terminals;
the first input unit is connected to the set terminal and a first junction and comprises a second terminal having a control terminal connected to the set terminal;
the second input unit comprises
a third transistor and a fourth transistor connected in parallel between the first junction and a gate voltage terminal,
a fifth transistor connected to a second junction and the gate voltage terminal, and
a first capacitor connected to the second junction and the first clock terminal,
wherein the third transistor comprises a control terminal connected to the reset terminal, the fourth transistor comprises a control terminal connected to the second junction, and the fifth transistor comprises a control terminal connected to the first junction;
the output voltage generator comprises
a sixth transistor connected a third junction and the first clock terminal, a seventh transistor and an eighth transistor connected in parallel between the third junction and the gate voltage terminal, and
a second capacitor connected to the first junction and the third junction,
wherein the sixth transistor comprises a control terminal connected to the first junction, the seventh transistor comprises a control terminal connected to second junction, and the eighth transistor comprises a control terminal connected to the second clock terminal; and
the first terminal of the first transistor is connected to the third junction.

6. The display device of claim 5, wherein at least one of the plurality of stages further comprises a carry out terminal that transmits the output signal to a previous stage and a next stage.

7. The display device of claim 4, wherein each of the plurality of stages further comprises a second selection terminal, and the output determiner determines whether the output signal outputs to the display panel assembly based on a second selection signal that is applied to the second selection terminal.

8. The display device of claim 7, wherein the output determiner further comprises a second transistor including a first terminal, a second terminal, and a control terminal,
wherein the first terminal is connected to a gate voltage terminal, the second terminal is connected to the output terminal, and the control terminal is connected to the second selection terminal.

9. The display device of claim 8, wherein the first transistor and the second transistor operate opposite to each other, and the first selection signal and the second selection signal are opposite in phase.

10. The display device of claim 9, wherein:
each of the plurality of stages further comprises a set terminal, a reset terminal, and first and second clock terminals;
the input unit comprises a third transistor that is connected between the set terminal and a first junction and has a control terminal connected with the set terminal;
the second input units comprises
fourth and fifth transistors connected in parallel between the first junction and the gate voltage terminal,
a sixth transistor connected between a second junction and the gate voltage terminal, and
a first capacitor connected between the second junction and the first clock terminal,
wherein the fourth transistor has a control terminal connected with the reset terminal, the fifth transistor has a control terminal connected with the second junction, and the sixth transistor has a control terminal connected with the first junction;
the output voltage generator comprises
a seventh transistor connected between a third contact and the first clock terminal,
eighth and ninth transistors connected in parallel between the third junction and the gate voltage terminal, and
a second capacitor connected between the first junction and the third junction,
wherein the seventh transistor has a control terminal connected with the first junction, the eighth transistor has a control terminal connected with the second junction, and the ninth transistor has a control terminal connected with the second clock terminal; and
the first and second transistors are connected with the third junction.

11. The display device of claim 10, wherein the at least one of the plurality of stages further comprises a carry output terminal that outputs the output signal to previous and next stages.

12. The display device of claim 3, wherein the output determiner outputs one of the output signal and a voltage applied to the gate voltage terminal based on the first selection signal.

13. The display device of claim 12, wherein the output determiner comprises a first transistor including a first terminal, a second terminal, and a control terminal, and a second transistor including a first terminal, a second terminal, and a control terminal,
wherein the first terminal of the first transistor is connected to the output voltage generator, the second terminal of the first transistor is connected to the output terminal, and the control terminal of the first transistor is connected to the output voltage generator, and the first terminal of the second transistor is connected to the gate voltage terminal, the second terminal of the second transistor is connected to the output terminal, and the control terminal of the second transistor is connected to the first selection terminal.

14. The display device of claim 13, wherein:
each of the plurality of stages further comprises a set terminal, a reset terminal, and first and second clock terminals;
the input unit comprises a third transistor that is connected between the set terminal and a first junction and has a control terminal connected with the set terminal;
the second input unit comprises
fourth and fifth transistors connected in parallel between the first junction and the gate voltage terminal,
a sixth transistor connected between a second junction and the gate voltage terminal, and
a first capacitor connected between the second junction and the first clock terminal,
wherein the third transistor has a control terminal connected with the reset terminal, the fifth transistor has a control terminal connected with the second junction, and the sixth transistor has a control terminal connected with the first junction;
the output voltage generator comprises
a seventh transistor connected between a third contact and the first clock terminal,
eighth and ninth transistors connected in parallel between the third junction and the gate voltage terminal, and
a second capacitor connected between the first junction and the third junction,
wherein the sixth transistor has a control terminal connected with the first junction, the eighth transistor has a control terminal connected with the second junction, and the ninth transistor has a control terminal connected with the second clock terminal; and
the first terminal of the first transistor is connected to the third junction.

15. The display device of claim 14, wherein the at least one of the plurality of stages further comprises a carry output terminal that outputs the output signal to previous and next stages.

16. The display device of claim 1, wherein the driver comprises a sense scanning driver that applies sense scanning signals to the signal lines,
and one stage of the plurality of stages comprises:
an input signal determiner that outputs a scanning start signal or one of output signals of previous stages;
an first input unit that outputs a first voltage in response to an output signal from the input signal determiner;
a second input unit that outputs a second voltage in response to one of the plurality of clock signals or one of output signals from a next stage; and
an output voltage generator to charge the first voltage and generating the output signal in response to the output signals from the first input unit and the second input unit.

17. The display device of claim 16, wherein the one stage comprises a first set terminal, a second set terminal, a first selection terminal, and a second selection terminal, and the input signal determiner outputs one of a signal from the first set terminal and a signal from the second set terminal based on signals applied to the first selection terminal and the second selection terminal to the first input unit.

18. The display device of claim 17, wherein the input signal determiner comprises a first transistor including a first terminal, a second terminal, and a control terminal,
wherein the first terminal is connected to the first set terminal, the second terminal is connected to the first input unit, and the control terminal is connected to the first selection terminal.

19. The display device of claim 18, wherein the input signal determiner further comprises a second transistor including a first terminal, a second terminal, and a control terminal,
wherein the first terminal is connected to the second set terminal, the second terminal is connected to the first input unit, and the control terminal is connected to the second selection terminal.

20. The display device of claim 19, wherein:
the one stage further comprises a reset terminal, first and second clock terminals, and a gate voltage terminal;
the first input unit is connected to the input signal determiner and a first junction and comprises a third transistor having a control terminal connected to the input signal determiner;
the second input unit comprises
a fourth transistor and a fifth transistor connected in parallel between the first junction and the gate voltage terminal,
a sixth transistor connected to a second junction and the gate voltage terminal, and
a first capacitor connected to the second junction and the first clock terminal,
wherein the fourth transistor comprises a control terminal connected to the reset terminal, the fifth transistor comprises a control terminal connected to the second junction, and the sixth transistor comprises a control terminal connected to the first junction; and
the output voltage generator comprises
a seventh transistor connected to a third junction and the first clock terminal,
an eighth transistor and a ninth transistor connected in parallel between the third junction and the gate voltage terminal, and
a second capacitor connected to the first junction and the third junction,
wherein the seventh transistor comprises a control terminal connected to the first junction, the eighth transistor comprises a control terminal connected to the second junction, and the ninth transistor comprises a control terminal connected to the second clock terminal.

21. The display device of claim 20, wherein the at least one of the plurality of stages further comprises a carry out terminal that transmits the output signal to a previous stage and a next stage.

22. The display device of claim 1, wherin the display panel assembly further comprises an electrophoretic layer.
